(19) United States
(12) Patent Application Publication
(10) Pub. No.: US 2018/0290149 A1
(43) Pub. Date: Oct. 11, 2018

(54) No Weld Replaceable Cutting Tooth Holder System

(71) Applicant: Diamond Mowers, LLC, Sioux Falls, SD (US)

(72) Inventors: Dave Ver Steeg, Sioux Falls, SD (US); Jordan Hagena, Sioux Falls, SD (US)

(73) Assignee: Diamond Mowers, LLC, Sioux Falls, SD (US)

(21) Appl. No.: 15/949,702

(22) Filed: Apr. 10, 2018

Related U.S. Application Data
(60) Provisional application No. 62/484,370, filed on Apr. 11, 2017.

(51) Int. Cl. B02C 18/18; B27L 11/00; A01G 3/00

(52) U.S. Cl. CPC B02C 18/184; A01G 3/002; B27L 11/005

(57) ABSTRACT

A no weld replaceable cutting tooth holder system facilitates replacement of cutting teeth on a cutting disc with improved durability, balance, and resistance to connection defects. The system includes a cutting disc and a holder having a connector and a socket. The holder is secured to the cutting disc without welding. The socket is configured for securement of a cutting tooth onto the cutting disc.

### CROSS-REFERENCE TO RELATED APPLICATIONS

We hereby claim the benefit under 35 U.S.C. Section 119(e) of U.S. Provisional application 62/484,370 filed on Apr. 11, 2017.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### 1 Field of the Invention.

### 2 Description of Related Art including information disclosed under 37 CFR 1.97 and 1.98.

The disclosure and prior art relates to cutting tooth holder devices and more particularly pertains to a new cutting tooth holder device for facilitating replacement of cutting teeth on a cutting disc with improved durability, balance, and resistance to connection defects.

### BRIEF SUMMARY OF THE INVENTION

An embodiment of the disclosure meets the needs presented above by generally comprising a cutting disc and a holder having a connector and a socket. The holder is secured to the cutting disc without welding. The socket is configured for securement of a cutting tooth onto the cutting disc.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a bottom perspective view of a no weld replaceable cutting tooth holder system according to an embodiment of the disclosure.

FIG. 2 is a top perspective view of a cutting disc of an embodiment of the disclosure.

FIG. 3 is a detailed perspective view of an edge holder of an embodiment of the disclosure.

FIG. 4 is a cross-sectional view of an embodiment of the disclosure taken along line 4-4 of FIG. 1.

FIG. 5 is a cross-sectional view of an embodiment of the disclosure taken along line 5-5 of FIG. 1.

FIG. 6 is a top perspective view of an interior holder of an embodiment of the disclosure.

FIG. 7 is a bottom plan view of an interior holder of an embodiment of the disclosure.

FIG. 8 is a top perspective view of an interior connection plate of an embodiment of the disclosure.

FIG. 9 is a bottom plan view of an edge holder of an embodiment of the disclosure.

FIG. 10 is a front view of an edge holder of an embodiment of the disclosure.

FIG. 11 is a top perspective view of an edge connection plate of an embodiment of the disclosure.

### DETAILED DESCRIPTION OF THE INVENTION

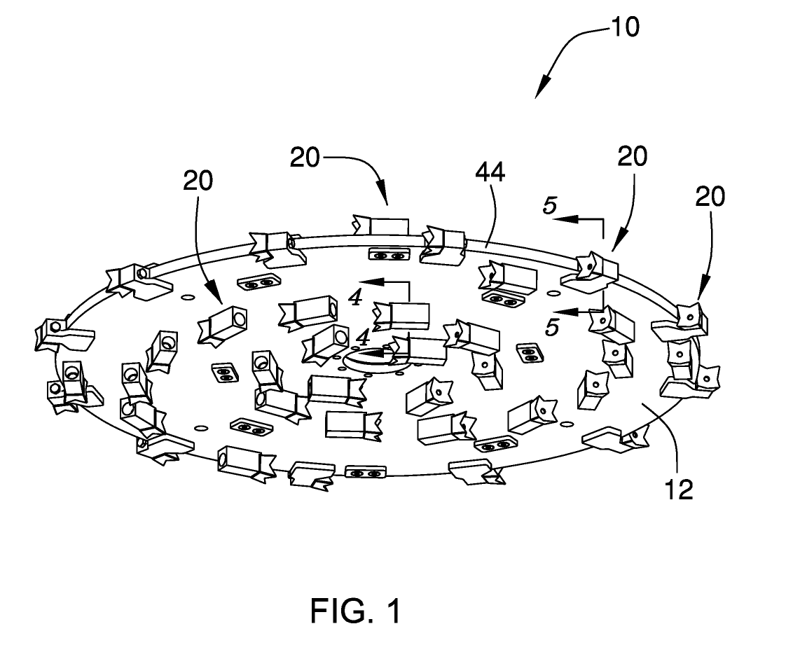

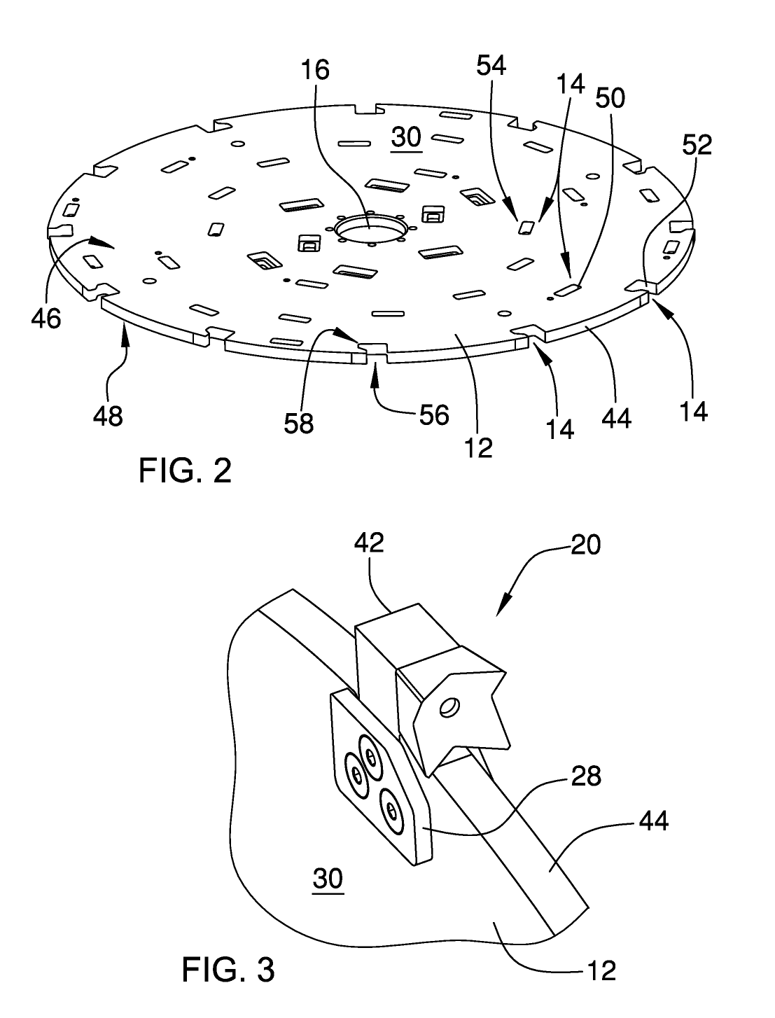

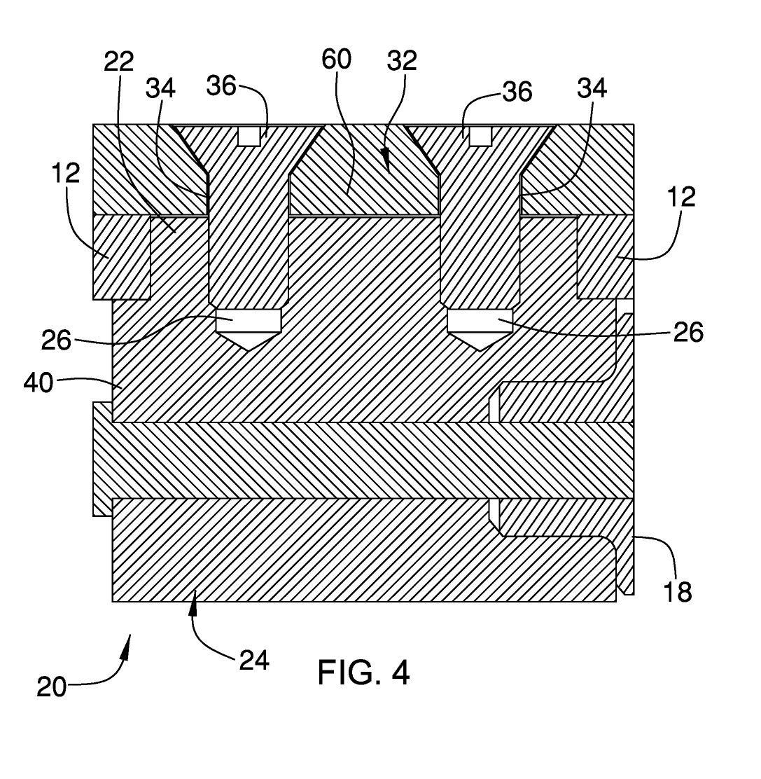

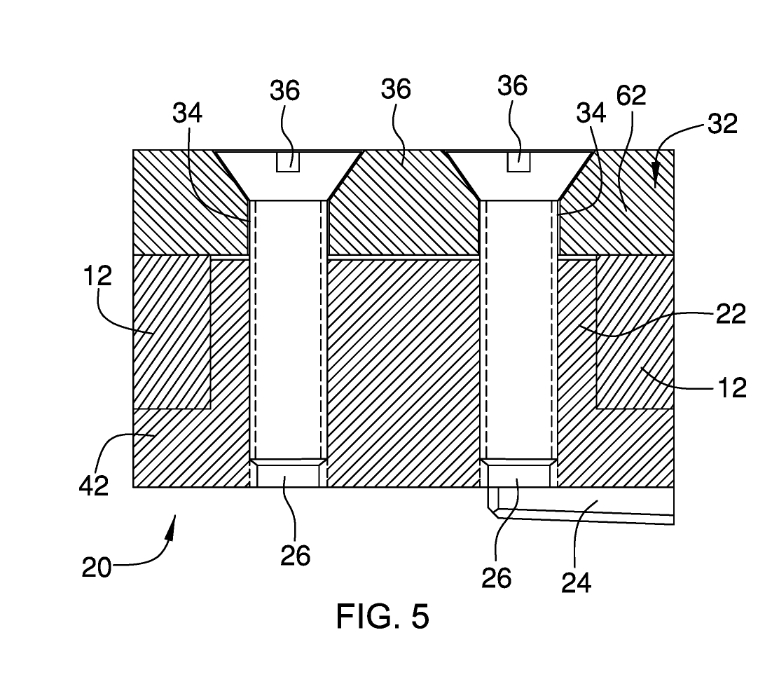

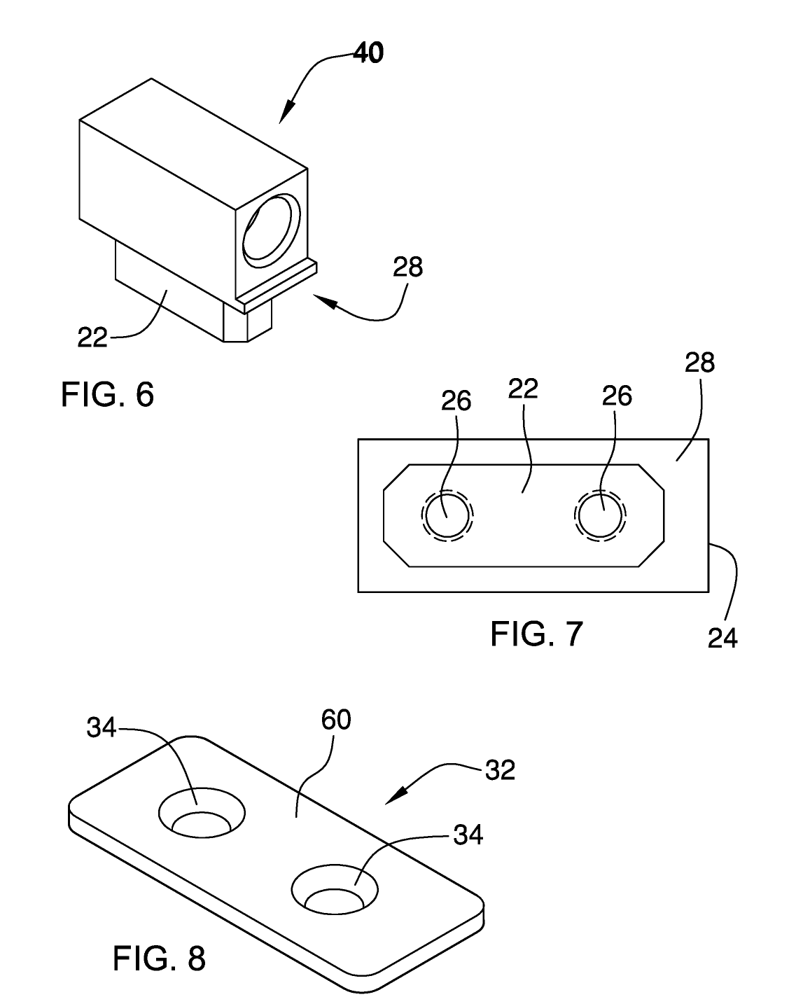

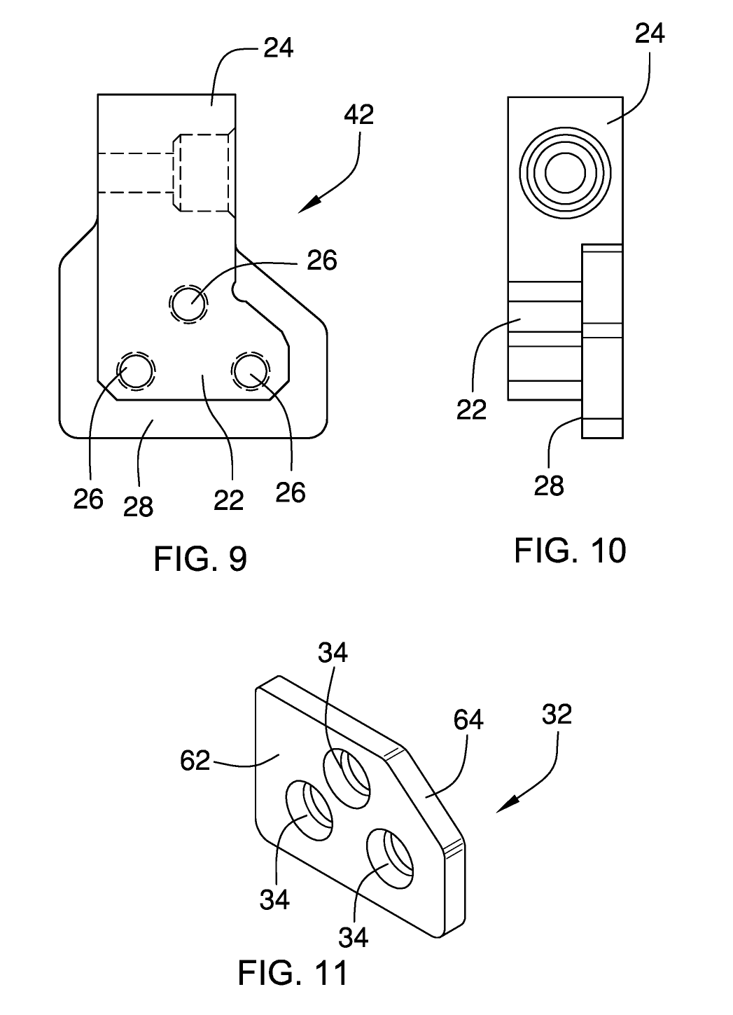

With reference now to the drawings, and in particular to FIGS. 1 through 11 thereof, a new cutting tooth holder device embodying the principles and concepts of an embodiment of the disclosure and generally designated by the reference numeral 10 will be described.

As best illustrated in FIGS. 1 through 11, the no weld replaceable cutting tooth holder system 10 generally comprises a cutting disc 12. The cutting disc 12 has a plurality of receivers 14 extending into the cutting disc 12. Each receiver 14 is a void extending through the cutting disc 12. The receivers 14 are distributed on the cutting disc 12 relative to a center 16 of the cutting disc 12 wherein a center of gravity of the cutting disc 12 corresponds to a center of rotation of the cutting disc 12 during use. Thus, the cutting disc 12 is balanced to inhibit vibration at high rortational speeds. The number of receivers 14 may be varied depending on the total number and positioning of cutting teeth 18 to be provided.

Generally, the system 10 incorporates a plurality of holders 20. Each holder 20 is secured to the cutting disc 12 by clamping as described herein as opposed to the conventional practice of welding pieces to the cutting disc 12 to provide for connection of replaceable cutting teeth. Each of the holders 20 generally comprises a connector 22 and a socket 24. The connector 22 is positionable in an associated one of the receivers 14 wherein the holder 20 is securable to the cutting disc 12 without welding. Each connector 22 has a plurality of connection holes 26 extending into the connector 22. Each of the connection holes 26 is threaded. Each connector 22 has an outer peripheral shape complementary to the associated one of the receivers 14 wherein the connector 22 inhibits lateral movement of the holder 20 relative to the cutting disc 12 when inserted into the associated one of the receivers 14. The specific shape of the connector 22 and receiver 14 may be symmetrical to allow for selectable orientation of the holder 20 relative to the cutting disc 12, or may be irregular to facilitate insertion of the connector 22 in a specific orientation relative to the cutting disc 12.

The socket 24 is configured for receiving and securing the cutting tooth 18 to the holder 20. The cutting tooth 18 is attached in a conventional manner. Each connector 22 extends from the socket 24 defining a planar flange 28 extending around the connector 22. The planar flange 28 abuts a face 30 of the cutting disc 12 when the connector 22 is inserted into the associated receiver 14.

Each of a plurality of connection plates 32 has a plurality of apertures 34 positioned to align with the connection holes 26 of an associated one of the connectors 22. A depth of each connector 22 is less than a thickness of the cutting disc 12 wherein the holder 20 is coupled to the cutting disc 12 by compressive force between the holder 20 and the connection plate 32. To achieve the compressive force, each of a plurality of fasteners 36 is extendable through a selectable one of the apertures 34 and the aligned connection hole 26 of the connector 22 such that tightening of the fastener 36 clamps the cutting disc 12 between the connection plate 32 and the holder 20, more specifically, the planar flange 28. The clamping provides the connective force and the positioning of the connector 22 within the associated receiver 14 minimizes shear on the fasteners 36. The apertures 34 and fasteners 36 may be structured so the fasteners 36 are countersunk into the connection plate 32.

The above description applies generally to each holder 20 but the plurality of holders 20 may include sub sets of holders 20. As shown in the drawing figures, the holders 20 generally may further include interior holders 40 and edge holders 42. Each of the interior holders 40 is positioned on the cutting disc 12 inwardly spaced from an outer peripheral edge 44 of the cutting disc 12. The connector 22 of each of the interior holders 42 is reversibly insertable into the associated one of the receivers 14 wherein the socket 24 is selectively positionable to be on a top face 46 or a bottom face 48 of the cutting disc 12 when the interior holder 40 is coupled to the cutting disc 12. Each of the edge holders 42 is positioned on the cutting disc 12 along the outer peripheral edge 44 of the cutting disc 12. Each of the interior holders 40 has an equivalent respective weight and structure whereby a center of gravity of the cutting disc 12 corresponds to the center of rotation of the cutting disc 12 when the interior holders 42 are coupled to the cutting disc 12. Each of the edge holders 42 is an equivalent weight and structure whereby a center of gravity of the cutting disc 12 corresponds to the center of rotation of the cutting disc 12 when the edge holders 42 are coupled to the cutting disc 12. With consistent and precise production of the holder 20, connection plate 32, and fastener 36 structures, balance in the cutting disc 12 is maintained.

As can be seen in the drawing figures, the receivers 14 generally would include interior receivers 50 and edge receivers 52 corresponding to the interior holders 40 and edge holders 42. The interior receivers 50 are generally rectangular prism shaped voids 54. The edge receivers 52 are generally a rectangular prism 56 with a generally triangular projection 58. The connection plates 32 also have variations corresponding to the interior holders 40 and edge holders 42. An interior connection plate 60 generally has two aligned apertures 34 while an edge connection plate 62 has a generally rectangular shape with a cut corner 64 and providing three apertures 34.

In use, the system 10 provides the equivalent of a conventional cutting disc having attached sockets for conventional attachment of replaceable cutting teeth. The structure described above and method of attaching holders 20 allows for lack of welding in coupling the holders 20 on the cutting disc 12. This prevents heat variation related inconsistencies in the integrity of the cutting disc 12 and allows for precision balance to reduce fatigue and vibration over time. Further, the holders 20 as well as the cutting teeth 18 may be replaced as needed while in the field.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A no weld replaceable cutting tooth holder system comprising:
a cutting disc;
a holder, said holder having a connector and a socket, said holder being secured to said cutting disc without welding, said socket being configured for securement of a cutting tooth onto the cutting disc.

2. The system of claim 1, further comprising said holder being coupled to said cutting disc by clamping.

3. A no weld replaceable cutting tooth holder system comprising:
a cutting disc, said cutting disc having a plurality of receivers extending into said cutting disc, said receivers being distributed on said cutting disc relative to a center of said cutting disc wherein a center of gravity of said cutting disc corresponds to a center of rotation of said cutting disc; and
a plurality of holders, each of said holders comprising
a connector, said connector being positionable in an associated one of said receivers wherein said holder is securable to said cutting disc without welding, and
a socket, said socket being configured for receiving and securing a cutting tooth to said holder.

4. The system of claim 3, further comprising each said holder being secured to said cutting disc by clamping.

5. The system of claim 3, further comprising said plurality of holders including interior holders, each of said interior holders being positioned on said cutting disc inwardly spaced from an outer peripheral edge of said cutting disc.

6. The system of claim 3, further comprising said plurality of holders including edge holders, each of said edge holders being positioned on said cutting disc along an outer peripheral edge of said cutting disc.

7. The system of claim 5, wherein each of said interior holders is an equivalent weight and structure whereby a center of gravity of said cutting disc corresponds to said center of rotation of said cutting disc when said holders are coupled to said cutting disc

8. The system of claim 6, wherein each of said edge holders is an equivalent weight and structure whereby a center of gravity of said cutting disc corresponds to said center of rotation of said cutting disc when said edge holders are coupled to said cutting disc.

9. The system of claim 3, further comprising;
each said connector having a plurality of connection holes extending into said connector;
a plurality of connection plates, each said connection plate having a plurality of apertures positioned to align with said connection holes of an associated one of said connectors; and
a plurality of fasteners, each said fastener being extendable through a selectable one of said apertures and said aligned connection hole of said connector such that tightening of said fastener clamps said cutting disc between said connection plate and said holder.

10. The system of claim 9, further comprising a depth of each said connector being less than a thickness of said cutting disc wherein said holder is coupled to said cutting disc by compressive force between said holder and said connection plate.

11. The system of claim 3, further comprising each said connector extending from said socket defining a planar flange extending around said connector, said planar flange abutting a face of said cutting disc when said connector is inserted into said associated receiver.

12. The system of claim 3, further comprising each said connector having an outer peripheral shape complementary to said associated one of said receivers wherein said connector inhibits lateral movement of said holder relative to said cutting disc when inserted into said associated one of said receivers.

13. The system of claim 5, further comprising said connector of each of said interior holders being reversibly insertable into said associated one of said receivers wherein said socket of said interior holder is selectively positionable to be on a top face or a bottom face of said cutting disc when said holder is coupled to said cutting disc.

14. A no weld replaceable cutting tooth holder system comprising:
a cutting disc, said cutting disc having a plurality of receivers extending into said cutting disc, said receivers being distributed on said cutting disc relative to a center of said cutting disc wherein a center of gravity of said cutting disc corresponds to a center of rotation of said cutting disc;
a plurality of holders, each said holder being secured to said cutting disc by clamping, each of said holders comprising
a connector, said connector being positionable in an associated one of said receivers wherein said holder is securable to said cutting disc without welding, each said connector having a plurality of connection holes extending into said connector, each of said connection holes being threaded, each said connector having an outer peripheral shape complementary to said associated one of said receivers wherein said connector inhibits lateral movement of said holder relative to said cutting disc when inserted into said associated one of said receivers, and
a socket, said socket being configured for receiving and securing a cutting tooth to said holder, each said connector extending from said socket defining a planar flange extending around said connector, said planar flange abutting a face of said cutting disc when said connector is inserted into said associated receiver;
a plurality of connection plates, each said connection plate having a plurality of apertures positioned to align with said connection holes of an associated one of said connectors, a depth of each said connector being less than a thickness of said cutting disc wherein said holder is coupled to said cutting disc by compressive force between said holder and said connection plate;
a plurality of fasteners, each said fastener being extendable through a selectable one of said apertures and said aligned connection hole of said connector such that tightening of said fastener clamps said cutting disc between said connection plate and said holder; and
said plurality of holders including interior holders and edge holders, each of said interior holders being positioned on said cutting disc inwardly spaced from an outer peripheral edge of said cutting disc, said connector of each of said interior holders being reversibly insertable into said associated one of said receivers wherein said socket is selectively positionable to be on a top face or a bottom face of said cutting disc when said holder is coupled to said cutting disc, each of said edge holders being positioned on said cutting disc along an outer peripheral edge of said cutting disc, each of said interior holders having an equivalent respective weight and structure whereby a center of gravity of said cutting disc corresponds to said center of rotation of said cutting disc when said interior holders are coupled to said cutting disc, each of said edge holders is an equivalent weight and structure whereby a center of gravity of said cutting disc corresponds to said center of rotation of said cutting disc when said edge holders are coupled to said cutting disc.
